(19) United States
(12) Patent Application Publication
(10) Pub. No.: US 2023/0315501 A1
(43) Pub. Date: Oct. 5, 2023

(54) Performance Monitoring Emulation in Translated Branch Instructions in a Binary Translation-Based Processor

(71) Applicant: Intel Corporation, Santa Clara, CA (US)

(72) Inventors: Sebastian Winkel, Los Altos, CA (US); Rangeen Basu Roy Chowdhury, Beaverton, OR (US); Matthew C. Merten, Hillsboro, OR (US); Jason M. Agron, San Jose, CA (US); Tyler N. Sondag, Beaverton, OR (US); Gregory A. Woods, El Dorado, CA (US)

(21) Appl. No.: 17/711,770

(22) Filed: Apr. 1, 2022

(51) Int. Cl. G06F 9/455

(52) U.S. Cl. CPC G06F 9/4552; G06F 9/45525

(57) ABSTRACT

Systems, methods, and devices for original code emulation for performance monitoring is provided. A system may memory to store instructions. A processor may implement an instruction converter in hardware or software to convert the instructions to translated code. Specifically, the instruction converter receives the instructions and translates the stored instructions into the translated code that includes one or more indexed instructions. The one or more indexed instructions include a field indicating a number of branches in the stored instructions that are taken in the translated code.

### BACKGROUND

This disclosure relates to performance monitor emulation in translated branch instructions that may be utilized in a binary translation-based processor or in a just-in-time compiler.

In a binary translation-based processor or a software Just-In-Time (JIT) compiler, translated code is used to execute operations. An optimization may include removing or altering the original code to generate the translated code. However, to maintain the illusion of the original dynamic code stream, breadcrumb instructions may be inserted into the translated code. These breadcrumbs may be implemented to not have any effect on control flow or data flow. These breadcrumbs may be a Branch Not-an-Operation (BRNOP) or a similar object. Although BRNOPs are technically “no ops” (NOP)s, they still occupy resources in the front end and retirement pipeline during normal execution, hence they add to the overhead of translated code execution. For example, unrolling a loop by a factor of four will add at least three BRNOPs in the translated code. These additional instructions at least partially minimize some benefits of optimization in the translated code. Furthermore, these breadcrumb instructions may only track some information (e.g., number of branches taken in the code) without tracking other information (e.g., branches not taken in the code). This additional information may be useful for various forms of performance monitoring. For instance, BRNOPs may be acceptable for a capability known as “perfmon”, but BRNOPs may not track additional information needed for processor trace (PT) or last branch record (LBR) performance monitoring.

### BRIEF DESCRIPTION OF THE DRAWINGS

Various aspects of this disclosure may be better understood upon reading the following detailed description and upon reference to the drawings in which:

FIG. 1 is a block diagram of a register architecture, in accordance with an embodiment;

FIG. 2A is a block diagram illustrating an in-order pipeline and a register renaming, out-of-order issue/execution pipeline, in accordance with an embodiment;

FIG. 2B is a block diagram illustrating an in-order architecture core and a register renaming, out-of-order issue/execution architecture core to be included in a processor, in accordance with an embodiment;

FIGS. 3A and 3B illustrate block diagrams of a more specific example in-order core architecture, in which a core would be one of several logic blocks (including other cores of the same type and/or different types) in a chip, in accordance with an embodiment;

FIG. 4 is a block diagram of a processor that may have more than one core, may have an integrated memory controller, and may have integrated graphics, in accordance with an embodiment;

FIG. 5 is a block diagram of a system, in accordance with an embodiment;

FIG. 6 is a block diagram of a first more specific example system, in accordance with an embodiment;

FIG. 7 is a block diagram of a second more specific example system, in accordance with an embodiment;

FIG. 8 is a block diagram of a system on a chip (SoC), in accordance with an embodiment;

FIG. 9 is a block diagram contrasting the use of a software instruction converter to convert binary instructions in a source instruction set to binary instructions in a target instruction set, in accordance with an embodiment;

FIG. 10 illustrates a loop unrolling optimization performed on code, in accordance with an embodiment;

FIG. 11 illustrates a translated flow generated from the code of FIG. 10 with branch not-an-operation instructions inserted, in accordance with an embodiment;

FIG. 12 illustrates the translated flow of FIG. 11 except that the branch-not-an-operation instructions are combined and replaced with a indexed instruction, in accordance with an embodiment;

FIG. 13 is a diagram of a data structure of the indexed instruction of FIG. 12, in accordance with an embodiment;

FIG. 14 is a flow diagram of a process utilizing the indexed instruction of FIG. 12, in accordance with an embodiment;

FIG. 15 illustrates a branch-to-assertion optimization, in accordance with an embodiment;

FIG. 16 is a diagram of a data structure that may be used to emulate the original code after a branch-to-assertion optimization, in accordance with an embodiment;

FIG. 17 illustrates branch-to-assertion optimization with alternative fusings, in accordance with an embodiment; and

FIG. 18 is a flow diagram of utilizing an extended instruction for the branch-to-assertion optimized code of FIG. 17, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B. Moreover, this disclosure describes various data structures, such as instructions for an instruction set architecture. These are described as having certain domains (e.g., fields) and corresponding numbers of bits. However, it should be understood that these domains and sizes in bits are meant as examples and are not intended to be exclusive. Indeed, the data structures (e.g., instructions) of this disclosure may take any suitable form.

This disclosure is related to binary translation. As previously noted, some processors or compilers may utilize translated code that undergoes binary recompilation from a source (original) instruction set to a target instruction set/translated code. This translated code is used in a binary translation-based processor. Additionally or alternatively, the translated code may be used in a software Just-In-Time (JIT) compiler that involves compilation during execution (e.g., at runtime) of the code rather than before execution. When the original code is translated, the code may be optimized. As used herein, optimized means enhanced by any degree and not necessarily the most optimum enhancement. For instance, the original code may be enhanced with loop unrolling and removing conditional branches during translation. For instance, the backward taken loop branch of the original code/instruction stream may be removed with additional copies of the looped instructions to reduce the number of branches. When translating to the original code, an optimization instruction set architecture (ISA) may be used that is the same ISA as the original or a different ISA may be used entirely. However, to maintain the illusion of the branches being present in the original dynamic code stream, breadcrumb instructions may be inserted in the translated code. These breadcrumbs typically do not have any effect on control flow or data flow and are only used by performance monitoring logic (perfmon, processor trace (PT), and Last Branch Record (LBR)) to update the architectural or microarchitectural performance counters and registers used in performance monitoring. These breadcrumb instructions help make binary translation/optimization transparent to the user by giving an illusion that the original code stream is being executed.

Other types of branches besides the backward loop branch can also be eliminated through optimizations such as branch-to-assert (B2A) conversion. This optimization uses branch bias profiling to convert a conditional branch to an assertion, such as by using an ASSERT instruction. The optimizer determines, using heuristics, that one branch is always or is almost always (e.g., 90+%) expected to follow a certain path. When that patch consists of multiple basic blocks, the code may combined into a single basic block with an assert replacing the branch. In other words, when a condition is biased heavily toward one outcome, the decision branch may be removed and altered to always track the most likely outcome.

However, variance from this outcome may still be tracked. For instance, there can be different kinds of assert instructions to check the path taken. For example, these assert instructions may include compare and trap (CAT) assertions, test and trap (TAT) assertions, and the like. During regular execution, an assertion checks to make sure that the assumption of the branch being biased still holds true. If the assumption turns out to be incorrect, the processor raises an exception (disruption) and the incorrect assumption is handled by the runtime software. Although these translated branches can change the control flow and data flow when the expected condition is not met, much more frequently these translated branches do not change the control flow and data flow during normal execution due to the heavy biasing requirements. CATs, TATs, and the like are independent compare instructions but are not NOPs. Since these assertions also replace branches in the original code stream, they act as breadcrumb instructions for perfmon emulation. For correct perfmon emulation, in an embodiment a special ASSERT instruction, ASSERT.Ps, is used, while standard ASSERT instructions may be used for assertions that do not utilize perfmon emulation. These ASSERT.P instructions indicate that the ASSERT instruction was in the original code prior to translation. As may be appreciated, ASSERT instructions also contribute to the overhead of execution and have the potential to create structural hazards in the front end of the processor as they are treated as pseudo-branches for state recovery purposes and write to ordering buffers. These ordering buffers have a limited number of write ports. Thus, these assert instructions can potentially reduce front end throughput.

Thus, accurate perfmon emulation of eliminated branches in the translated code increases the number of non-functional instructions causing code bloat and cache pressure. This additional overhead also increases the number of writers to branch ordering queues causing low throughput whenever a write port restriction cap is hit. Moreover, breadcrumb instructions must represent branches in the same order as order as the original program to correctly update PT and LBR.

To address the foregoing issues, new instructions may be used to combine several BRNOP or ASSERT instructions into a single instruction. These new instructions may meet the monitoring requirements while reducing the use of the pipeline resources. For instance, a Branch Not-an-Operation N (BRNOPN) instruction may combine multiple BRNOPs into a single instruction where ‘N’ is the number of BRNOPs combined. Specifically, BRNOPN represents N copies of one static taken branch, such as the backward loop branch, that is replicated due to loop unrolling in the translated code as described herein.

Another novel instruction may be an “Extended BRNOPN” (EBRNOPN) that allows interleaving not-taken conditional breadcrumb instructions along with taken conditional breadcrumb instructions. These not-taken breadcrumb instructions may occur as ASSERT.Ps in the code as a result of branch-to-assert optimization.

The use of BRNOPN and EBRNOPN instructions may reduce the number of non-functional instructions flowing through the pipeline. As previously noted, these non-functional instructions cause unnecessary structural hazards and reduced overall throughput. Moreover, unlike BRNOPN, EBRNOPN can combine multiple not-taken breadcrumbs to further reduce the overhead when optimizing the code. Furthermore, the ASSERT.Ps may be replaced in the code with ASSERTs once the branch representations are fused into an EBRNOPN. This is because the ASSERTs do not need to allocate into the branch ordering queue and, thus do not artificially reduce front end throughput.

### Register Architecture

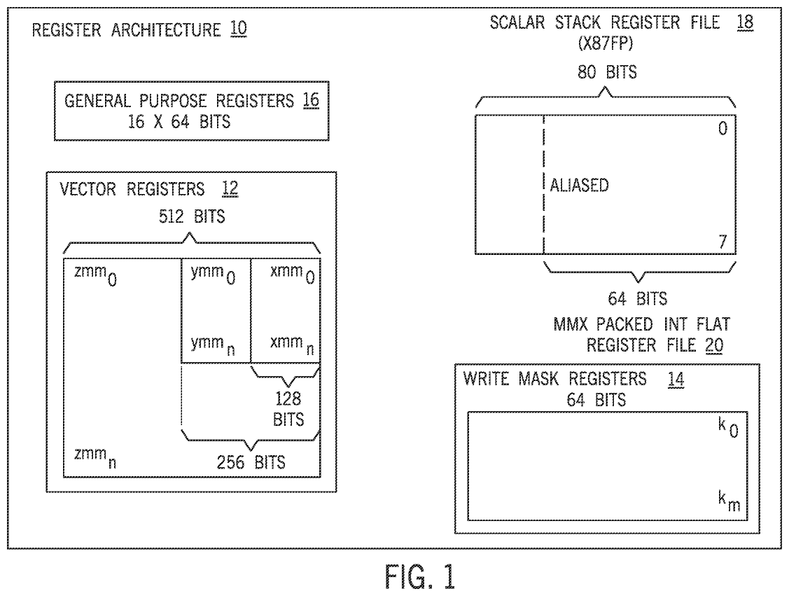

FIG. 1 is a block diagram of a register architecture 10, in accordance with an embodiment. In the embodiment illustrated, there are a number (e.g., 32) of vector registers 12 that may be a number (e.g., 512) of bits wide. In the register architecture 10; these registers are referenced as zmm0 through zmmi. The lower order (e.g., 256) bits of the lower n (e.g., 16) zmm registers are overlaid on corresponding registers ymm. The lower order (e.g., 128 bits) of the lower n zmm registers that are also the lower order n bits of the ymm registers are overlaid on corresponding registers xmm.

Write mask registers 14 may include m (e.g., 8) write mask registers (k0 through km), each having a number (e.g., 64) of bits. Additionally or alternatively, at least some of the write mask registers 14 may have a different size (e.g., 16 bits). At least some of the vector mask registers 12 (e.g., k0) are prohibited from being used as a write mask. When such vector mask registers are indicated, a hardwired write mask (e.g., 0xFFFF) is selected and, effectively disabling write masking for that instruction.

General-purpose registers 16 may include a number (e.g., 16) of registers having corresponding bit sizes (e.g., 64) that are used along with x86 addressing modes to address memory operands. These registers may be referenced by the names RAX, RBX, RCX, RDX, RBP, RSI, RDI, RSP, and R8 through R15. Parts (e.g., 32 bits of the registers) of at least some of these registers may be used for modes (e.g., 32-bit mode) that is shorter than the complete length of the registers.

Scalar floating-point stack register file (x87 stack) 18 has an MMX packed integer flat register file 20 is aliased. The x87 stack 18 is an eight-element (or other number of elements) stack used to perform scalar floating-point operations on floating point data using the x87 instruction set extension. The floating-point data may have various levels of precision (e.g., 16, 32, 64, 80, or more bits). The MMX packed integer flat register files 20 are used to perform operations on 64-bit packed integer data, as well as to hold operands for some operations performed between the MMX packed integer flat register files 20 and the XMM registers.

Alternative embodiments may use wider or narrower registers. Additionally, alternative embodiments may use more, less, or different register files and registers.

### Core Architectures, Processors, and Computer Architectures

Processor cores may be implemented in different ways, for different purposes, and in different processors. For instance, implementations of such cores may include: 1) a general purpose in-order core suitable for general-purpose computing; 2) a high performance general purpose out-of-order core suitable for general-purpose computing; 3) a special purpose core suitable for primarily for graphics and/or scientific (throughput) computing. Implementations of different processors may include: 1) a CPU including one or more general purpose in-order cores suitable for general-purpose computing and/or one or more general purpose out-of-order cores suitable for general-purpose computing; and 2) a coprocessor including one or more special purpose cores primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Example core architectures are described next, followed by descriptions of example processors and computer architectures.

### In-Order and Out-of-Order Core Architecture

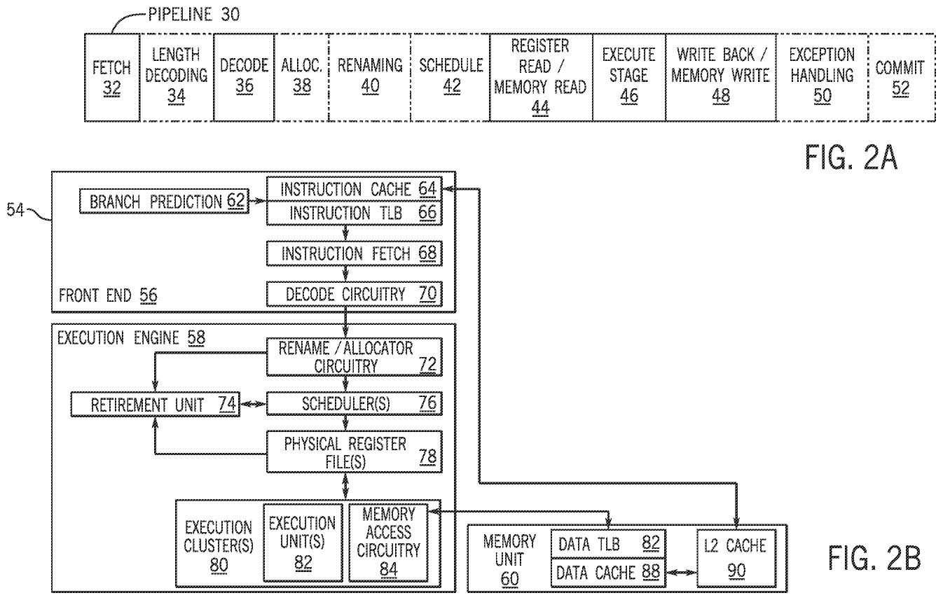

FIG. 2A is a block diagram illustrating an in-order pipeline and a register renaming, out-of-order issue/execution pipeline according to an embodiment of the disclosure. FIG. 2B is a block diagram illustrating both an embodiment of an in-order architecture core and an example register renaming, out-of-order issue/execution architecture core to be included in a processor according to embodiments. The solid lined boxes in FIGS. 2A and 2B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 2A, a pipeline 30 in the processor includes a fetch stage 32, a length decode stage 34, a decode stage 36, an allocation stage 38, a renaming stage 40, a scheduling (also known as a dispatch or issue) stage 42, a register read/memory read stage 44, an execute stage 46, a write back/memory write stage 48, an exception handling stage 50, and a commit stage 52.

FIG. 2B shows a processor core 54 including a front-end unit 56 coupled to an execution engine unit 58, and both are coupled to a memory unit 60. The processor core 54 may be a reduced instruction set computing (RISC) core, a complex instruction set computing (CISC) core, a very long instruction word (VLIW) core, or a hybrid or alternative core type. As yet another option, the processor core 54 may be a special-purpose core, such as, for example, a network or communication core, compression engine, coprocessor core, general purpose computing graphics processing unit (GPGPU) core, graphics core, or the like.

The front-end unit 56 includes a branch prediction unit 62 coupled to an instruction cache unit 64 that is coupled to an instruction translation lookaside buffer (TLB) 66. The TLB 66 is coupled to an instruction fetch unit 68. The instruction fetch unit 68 is coupled to a decode circuitry 70. The decode circuitry 70 (or decoder) may decode instructions and generate as an output one or more micro-operations, micro-code entry points, microinstructions, other instructions, or other control signals, which are decoded from, or which otherwise reflect, or are derived from, the original instructions. The decode circuitry 70 may be implemented using various different mechanisms. Examples of suitable mechanisms include, but are not limited to, look-up tables, hardware implementations, programmable logic arrays (PLAs), microcode read only memories (ROMs), etc. The processor core 54 may include a microcode ROM or other medium that stores microcode for macroinstructions (e.g., in decode circuitry 70 or otherwise within the front-end unit 56). The decode circuitry 70 is coupled to a rename/allocator unit 72 in the execution engine unit 58.

The execution engine unit 58 includes a rename/allocator unit 72 coupled to a retirement unit 74 and a set of one or more scheduler unit(s) 76. The scheduler unit(s) 76 represents any number of different schedulers, including reservations stations, central instruction window, etc. The scheduler unit(s) 76 is coupled to physical register file(s) unit(s) 78. Each of the physical register file(s) unit(s) 78 represents one or more physical register files storing one or more different data types, such as scalar integers, scalar floating points, packed integers, packed floating points, vector integers, vector floating points, statuses (e.g., an instruction pointer that is the address of the next instruction to be executed), etc. In one embodiment, the physical register file(s) unit(s) 78 includes the vector registers 12, the write mask registers 14, and/or the x87 stack 18. These register units may provide architectural vector registers, vector mask registers, and general-purpose registers. The physical register file(s) unit(s) 78 is overlapped by the retirement unit 74 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.).

The retirement unit 74 and the physical register file(s) unit(s) 78 are coupled to an execution cluster(s) 80. The execution cluster(s) 80 includes a set of one or more execution units 82 and a set of one or more memory access circuitries 84. The execution units 82 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform multiple different functions. The scheduler unit(s) 76, physical register file(s) unit(s) 78, and execution cluster(s) 80 are shown as being singular or plural because some processor cores 54 create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster. In the case of a separate memory access pipeline, a processor core 54 for the separate memory access pipeline is the only the execution cluster 80 that has the memory access circuitry 84). It should also be understood that where separate pipelines are used, one or more of these pipelines may be out-of-order issue/execution and the rest perform in-order execution.

The set of memory access circuitry 84 is coupled to the memory unit 60. The memory unit 60 includes a data TLB unit 86 coupled to a data cache unit 88 coupled to a level 2 (L2) cache unit 90. The memory access circuitry 84 may include a load unit, a store address unit, and a store data unit, each of which is coupled to the data TLB unit 86 in the memory unit 60. The instruction cache unit 64 is further coupled to the level 2 (L2) cache unit 90 in the memory unit 60. The L2 cache unit 90 is coupled to one or more other levels of caches and/or to a main memory.

By way of example, the register renaming, out-of-order issue/execution core architecture may implement the pipeline 30 as follows: 1) the instruction fetch unit 68 performs the fetch and length decoding stages 32 and 34 of the pipeline 30; 2) the decode circuitry 70 performs the decode stage 36 of the pipeline 30; 3) the rename/allocator unit 72 performs the allocation stage 38 and renaming stage 40 of the pipeline; 4) the scheduler unit(s) 76 performs the schedule stage 42 of the pipeline 30; 5) the physical register file(s) unit(s) 78 and the memory unit 60 perform the register read/memory read stage 44 of the pipeline 30; the execution cluster 80 performs the execute stage 46 of the pipeline 30; 6) the memory unit 60 and the physical register file(s) unit(s) 78 perform the write back/memory write stage 48 of the pipeline 30; 7) various units may be involved in the exception handling stage 50 of the pipeline; and/or 8) the retirement unit 74 and the physical register file(s) unit(s) 78 perform the commit stage 52 of the pipeline 30.

The processor core 54 may support one or more instructions sets, such as an x86 instruction set (with or without additional extensions for newer versions); a MIPS instruction set of MIPS Technologies of Sunnyvale, CA; an ARM instruction set (with optional additional extensions such as NEON) of ARM Holdings of Sunnyvale, CA). Additionally or alternatively, the processor core 54 includes logic to support a packed data instruction set extension (e.g., AVX1, AVX2), thereby allowing the operations used by multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof, such as a time-sliced fetching and decoding and simultaneous multithreading in INTEL® Hyperthreading technology.

While register renaming is described in the context of out-of-order execution, register renaming may be used in an in-order architecture. While the illustrated embodiment of the processor also includes a separate instruction cache unit 64, a separate data cache unit 88, and a shared L2 cache unit 90, some processors may have a single internal cache for both instructions and data, such as, for example, a Level 1 (L1) internal cache, or multiple levels of the internal cache. In some embodiments, the processor may include a combination of an internal cache and an external cache that is external to the processor core 54 and/or the processor. Alternatively, some processors may use a cache that is external to the processor core 54 and/or the processor.

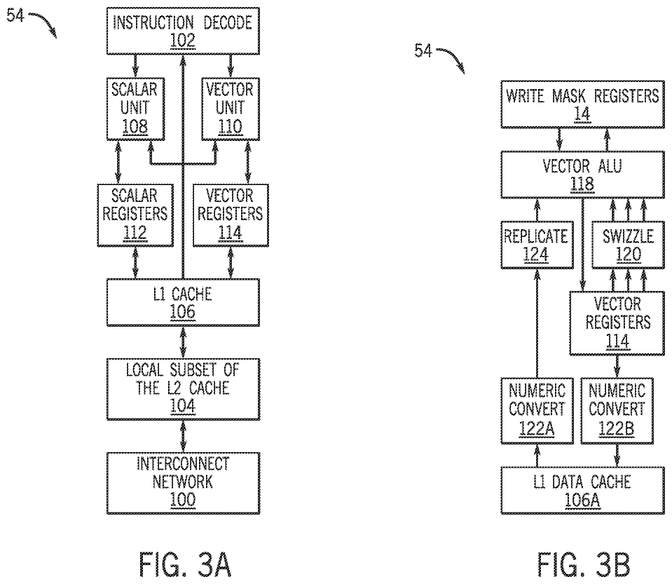

FIGS. 3A and 3B illustrate more detailed block diagrams of an in-order core architecture. The processor core 54 includes one or more logic blocks (including other cores of the same type and/or different types) in a chip. The logic blocks communicate through a high-bandwidth interconnect network (e.g., a ring network) with some fixed function logic, memory I/O interfaces, and other I/O logic, depending on the application.

FIG. 3A is a block diagram of a single processor core 54, along with its connection to an on-die interconnect network 100 and with its local subset of the Level 2 (L2) cache 104, according to embodiments of the disclosure. In one embodiment, an instruction decoder 102 supports the x86 instruction set with a packed data instruction set extension. An L1 cache 106 allows low-latency accesses to cache memory into the scalar and vector units. While in one embodiment (to simplify the design), a scalar unit 108 and a vector unit 110 use separate register sets (respectively, scalar registers 112 (e.g., x87 stack 18) and vector registers 114 (e.g., vector registers 12) and data transferred between them is written to memory and then read back in from a level 1 (L1) cache 106, alternative embodiments of the disclosure may use a different approach (e.g., use a single register set or include a communication path that allow data to be transferred between the two register files without being written and read back).

The local subset of the L2 cache 104 is part of a global L2 cache unit 90 that is divided into separate local subsets, one per processor core. Each processor core 54 has a direct access path to its own local subset of the L2 cache 104. Data read by a processor core 54 is stored in its L2 cache 104 subset and can be accessed quickly, in parallel with other processor cores 54 accessing their own local L2 cache subsets. Data written by a processor core 54 is stored in its own L2 cache 104 subset and is flushed from other subsets, if necessary. The interconnection network 100 ensures coherency for shared data. The interconnection network 100 is bi-directional to allow agents such as processor cores, L2 caches, and other logic blocks to communicate with each other within the chip. Each data-path may have a number (e.g., 1012) of bits in width per direction.

FIG. 3B is an expanded view of part of the processor core in FIG. 3A according to embodiments of the disclosure. FIG. 3B includes an L1 data cache 106A part of the L1 cache 106, as well as more detail regarding the vector unit 110 and the vector registers 114. Specifically, the vector unit 110 may be a vector processing unit (VPU) (e.g., a vector arithmetic logic unit (ALU) 118) that executes one or more of integer, single-precision float, and double-precision float instructions. The VPU supports swizzling the register inputs with swizzle unit 120, numeric conversion with numeric convert units 122A and 122B, and replication with replication unit 124 on the memory input. The write mask registers 14 allow predicating resulting vector writes.

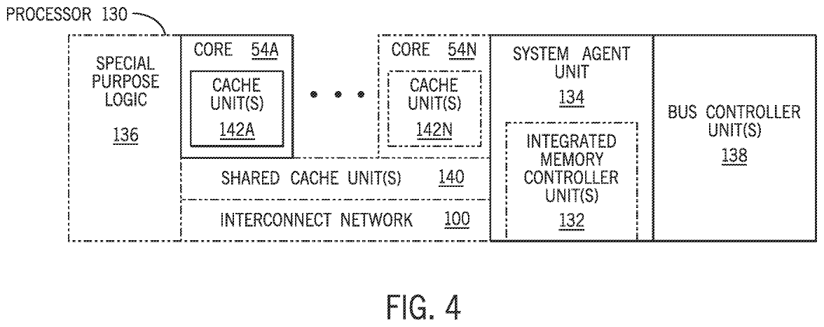

FIG. 4 is a block diagram of a processor 130 that may have more than one processor core 54, may have an integrated memory controller unit(s) 132, and may have integrated graphics according to embodiments of the disclosure. The solid lined boxes in FIG. 4 illustrate a processor 130 with a single core 54A, a system agent unit 134, a set of one or more bus controller unit(s) 138, while the optional addition of the dashed lined boxes illustrates the processor 130 with multiple cores 54A-N, a set of one or more integrated memory controller unit(s) 132 in the system agent unit 134, and a special purpose logic 136.

Thus, different implementations of the processor 130 may include: 1) a CPU with the special purpose logic 136 being integrated graphics and/or scientific (throughput) logic (which may include one or more cores), and the cores 54A-N being one or more general purpose cores (e.g., general purpose in-order cores, general purpose out-of-order cores, or a combination thereof); 2) a coprocessor with the cores 54A-N being a relatively large number of special purpose cores intended primarily for graphics and/or scientific (throughput); and 3) a coprocessor with the cores 54A-N being a relatively large number of general purpose in-order cores. Thus, the processor 130 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), an embedded processor, or the like. The processor 130 may be implemented on one or more chips. The processor 130 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 140, and external memory (not shown) coupled to the set of integrated memory controller unit(s) 132. The set of shared cache units 140 may include one or more mid-level caches, such as level 2 (L2), level 3 (L3), level 4 (L4), or other levels of cache, a last level cache (LLC), and/or combinations thereof. While a ring-based interconnect network 100 may interconnect the integrated graphics logic 136 (integrated graphics logic 136 is an example of and is also referred to herein as special purpose logic 136), the set of shared cache units 140, and/or the system agent unit 134/integrated memory controller unit(s) 132 may use any number of known techniques for interconnecting such units. For example, coherency may be maintained between one or more cache units 142A-N and cores 54A-N.

In some embodiments, one or more of the cores 54A-N are capable of multi-threading. The system agent unit 134 includes those components coordinating and operating cores 54A-N. The system agent unit 134 may include, for example, a power control unit (PCU) and a display unit. The PCU may be or may include logic and components used to regulate the power state of the cores 54A-N and the integrated graphics logic 136. The display unit is used to drive one or more externally connected displays.

The cores 54A-N may be homogenous or heterogeneous in terms of architecture instruction set. That is, two or more of the cores 54A-N may be capable of execution of the same instruction set, while others may be capable of executing only a subset of a single instruction set or a different instruction set.

### Computer Architecture

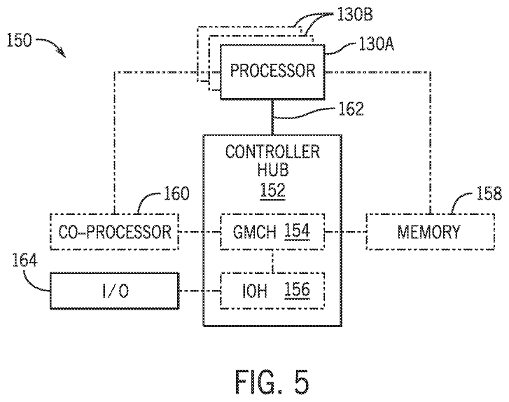

FIGS. 5-8 are block diagrams of embodiments of computer architectures. These architectures may be suitable for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices. In general, a wide variety of systems or electronic devices capable of incorporating the processor 130 and/or other execution logic.

Referring now to FIG. 5, shown is a block diagram of a system 150 in accordance with an embodiment. The system 150 may include one or more processors 130A, 130B that is coupled to a controller hub 152. The controller hub 152 may include a graphics memory controller hub (GMCH) 154 and an Input/Output Hub (IOH) 156 (which may be on separate chips); the GMCH 154 includes memory and graphics controllers to which are coupled memory 158 and a coprocessor 160; the IOH 156 couples input/output (I/O) devices 164 to the GMCH 154. Alternatively, one or both of the memory and graphics controllers are integrated within the processor 130 (as described herein), the memory 158 and the coprocessor 160 are coupled to (e.g., directly to) the processor 130A, and the controller hub 152 in a single chip with the IOH 156.

The optional nature of an additional processor 130B is denoted in FIG. 5 with broken lines. Each processor 130A, 130B may include one or more of the processor cores 54 described herein and may be some version of the processor 130.

The memory 158 may be, for example, dynamic random-access memory (DRAM), phase change memory (PCM), or a combination thereof. For at least one embodiment, the controller hub 152 communicates with the processor(s) 130A, 130B via a multi-drop bus, such as a frontside bus (FSB), point-to-point interface such as QuickPath Interconnect (QPI), or similar connection 162.

In one embodiment, the coprocessor 160 is a special-purpose processor, such as, for example, a high-throughput MIC processor, a network or communication processor, a compression engine, a graphics processor, a GPGPU, an embedded processor, or the like. In an embodiment, the controller hub 152 may include an integrated graphics accelerator.

There can be a variety of differences between the physical resources of the processors 130A, 130B in terms of a spectrum of metrics of merit including architectural, microarchitectural, thermal, power consumption characteristics, and the like.

In some embodiments, the processor 130A executes instructions that control data processing operations of a general type. Embedded within the instructions may be coprocessor instructions. The processor 130A recognizes these coprocessor instructions as being of a type that should be executed by the attached coprocessor 160. Accordingly, the processor 130A issues these coprocessor instructions (or control signals representing coprocessor instructions) on a coprocessor bus or other interconnect, to the coprocessor 160. The coprocessor 160 accepts and executes the received coprocessor instructions.

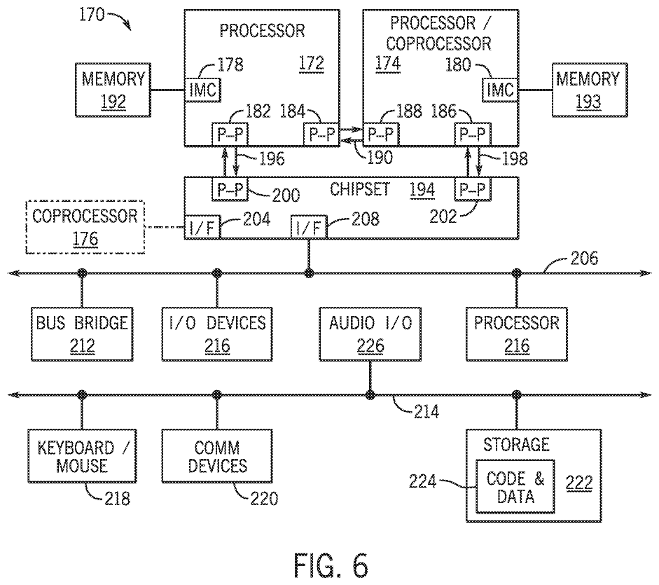

Referring now to FIG. 6, shown is a more detailed block diagram of a multiprocessor system 170 in accordance with an embodiment. As shown in FIG. 6, the multiprocessor system 170 is a point-to-point interconnect system, and includes a processor 172 and a processor 174 coupled via a point-to-point interface 190. Each of processors 172 and 174 may be some version of the processor 130. In one embodiment of the disclosure, processors 172 and 174 are respectively processors 130A and 130B, while coprocessor 176 is coprocessor 160. In another embodiment, processors 172 and 174 are respectively processor 130A and coprocessor 160.

Processors 172 and 174 are shown including integrated memory controller (IMC) units 178 and 180, respectively. The processor 172 also includes point-to-point (P-P) interfaces 182 and 184 as part of its bus controller units. Similarly, the processor 174 includes P-P interfaces 186 and 188. The processors 172, 174 may exchange information via a point-to-point interface 190 using P-P interfaces 184, 188. As shown in FIG. 6, IMCs 178 and 180 couple the processors to respective memories, namely a memory 192 and a memory 193 that may be different portions of main memory locally attached to the respective processors 172, 174.

Processors 172, 174 may each exchange information with a chipset 194 via individual P-P interfaces 196, 198 using point-to-point interfaces 182, 200, 186, 202. Chipset 194 may optionally exchange information with the coprocessor 176 via a high-performance interface 204. In an embodiment, the coprocessor 176 is a special-purpose processor, such as, for example, a high-throughput MIC processor, a network or communication processor, a compression engine, a graphics processor, a GPGPU, an embedded processor, or the like.

A shared cache (not shown) may be included in either processor 172 or 174 or outside of both processors 172 or 174 that is connected with the processors 172, 174 via respective P-P interconnects such that either or both processors' local cache information may be stored in the shared cache if a respective processor is placed into a low power mode.

The chipset 194 may be coupled to a first bus 206 via an interface 208. In an embodiment, the first bus 206 may be a Peripheral Component Interconnect (PCI) bus or a bus such as a PCI Express bus or another third generation I/O interconnect bus, although the scope of the present disclosure is not so limited.

As shown in FIG. 6, various I/O devices 210 may be coupled to first bus 206, along with a bus bridge 212 that couples the first bus 206 to a second bus 214. In an embodiment, one or more additional processor(s) 216, such as coprocessors, high-throughput MIC processors, GPGPUs, accelerators (such as, e.g., graphics accelerators or digital signal processing (DSP) units), field programmable gate arrays, or any other processors, are coupled to the first bus 206. In an embodiment, the second bus 214 may be a low pin count (LPC) bus. Various devices may be coupled to the second bus 214 including, for example, a keyboard and/or mouse 218, communication devices 220 and a storage unit 222 such as a disk drive or other mass storage device which may include instructions/code and data 224, in an embodiment. Further, an audio I/O 226 may be coupled to the second bus 214. Note that other architectures may be deployed for the multiprocessor system 170. For example, instead of the point-to-point architecture of FIG. 6, the multiprocessor system 170 may implement a multi-drop bus or other such architectures.

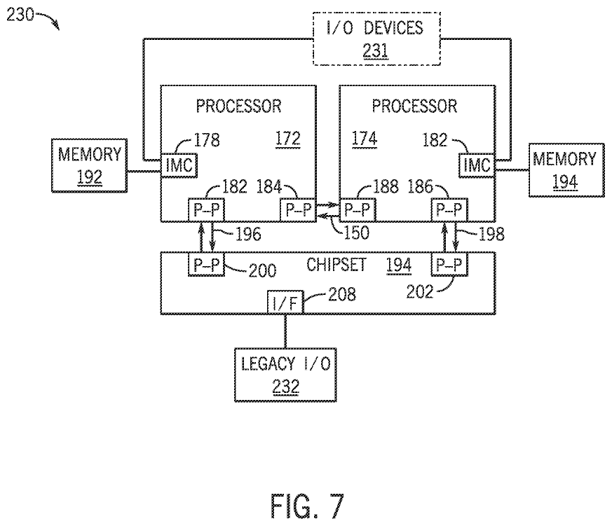

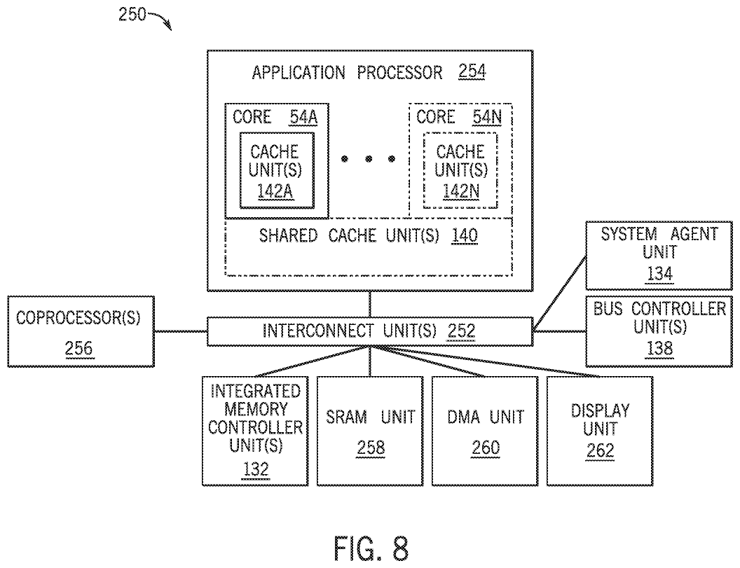

Referring now to FIG. 7, shown is a block diagram of a system 230 in accordance with an embodiment. Like elements in FIGS. 7 and 8 contain like reference numerals, and certain aspects of FIG. 6 have been omitted from FIG. 7 to avoid obscuring other aspects of FIG. 7.

FIG. 7 illustrates that the processors 172, 174 may include integrated memory and I/O control logic (“IMC”) 178 and 180, respectively. Thus, the IMC 178, 180 include integrated memory controller units and include I/O control logic. FIG. 7 illustrates that not only are the memories 192, 193 coupled to the IMC 178, 180, but also that I/O devices 231 are also coupled to the IMC 178, 180. Legacy I/O devices 232 are coupled to the chipset 194 via interface 208.

Referring now to FIG. 8, shown is a block diagram of a SoC 250 in accordance with an embodiment. Similar elements in FIG. 4 have like reference numerals. Also, dashed lined boxes are optional features included in some SoCs 250. In FIG. 8, an interconnect unit(s) 252 is coupled to: an application processor 254 that includes a set of one or more cores 54A-N that includes cache units 142A-N, and shared cache unit(s) 140; a system agent unit 134; a bus controller unit(s) 138; an integrated memory controller unit(s) 132; a set or one or more coprocessors 256 that may include integrated graphics logic, an image processor, an audio processor, and/or a video processor; a static random access memory (SRAM) unit 258; a direct memory access (DMA) unit 260; and a display unit 262 to couple to one or more external displays. In an embodiment, the coprocessor(s) 256 include a special-purpose processor, such as, for example, a network or communication processor, a compression engine, a GPGPU, a high-throughput MIC processor, an embedded processor, or the like.

Embodiments of the mechanisms disclosed herein may be implemented in hardware, software, firmware, or a combination of such implementation approaches. Embodiments of the disclosure may be implemented as computer programs and/or program code executing on programmable systems including at least one processor, a storage system (including volatile and non-volatile memory and/or storage elements), at least one input device, and at least one output device.

Program code, such as data 224 illustrated in FIG. 6, may be applied to input instructions to perform the functions described herein and generate output information. The output information may be applied to one or more output devices. For purposes of this application, a processing system includes any system that has a processor, such as, for example, a digital signal processor (DSP), a microcontroller, an application-specific integrated circuit (ASIC), or a microprocessor.

The program code may be implemented in a high-level procedural or object-oriented programming language to communicate with a processing system. The program code may also be implemented in an assembly language or in a machine language. In fact, the mechanisms described herein are not limited in scope to any particular programming language. In any case, the language may be a compiled language or an interpreted language.

One or more aspects of at least one embodiment may be implemented by representative instructions stored on a machine-readable medium that represents various logic within the processor that, when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic cards, optical cards, or any other type of media suitable for storing electronic instructions.

Accordingly, embodiments of the embodiment include non-transitory, tangible machine-readable media containing instructions or containing design data, such as designs in Hardware Description Language (HDL) that may define structures, circuits, apparatuses, processors and/or system features described herein. Such embodiments may also be referred to as program products.

### Emulation and Code Optimization

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert instructions to one or more other instructions to be processed by the core. The instruction converter may be implemented in software, hardware, firmware, or a combination thereof. The instruction converter may be implemented on processor, off processor, or part on and part off processor.

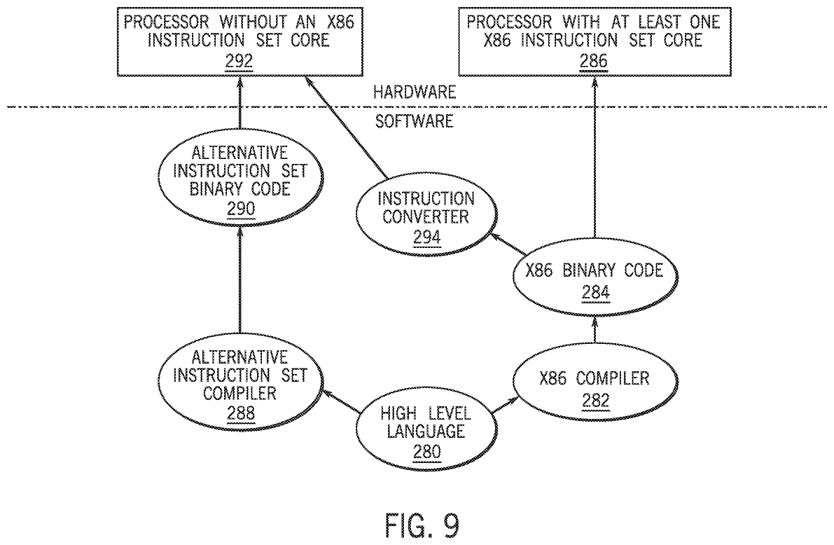

FIG. 9 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or any combinations thereof. FIG. 9 shows a program in a high-level language 280 may be compiled using an x86 compiler 282 to generate x86 binary code 284 that may be natively executed by a processor with at least one x86 instruction set core 286. The processor with at least one x86 instruction set core 286 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 282 represents a compiler that is operable to generate x86 binary code 284 (e.g., object code) that can, with or without additional linkage processing, be executed on the processor with at least one x86 instruction set core 286.

Similarly, FIG. 9 shows the program in the high-level language 280 may be compiled using an alternative instruction set compiler 288 to generate alternative instruction set binary code 290 that may be natively executed by a processor without at least one x86 instruction set core 292 (e.g., a processor with processor cores 54 that execute the MIPS instruction set of MIPS Technologies of Sunnyvale, CA and/or that execute the ARM instruction set of ARM Holdings of Sunnyvale, CA). An instruction converter 294 is used to convert the x86 binary code 284 into code that may be natively executed by the processor without an x86 instruction set core 292. This converted code is not likely to be the same as the alternative instruction set binary code 290; however, the converted code may accomplish the general operation and be made up of instructions from the alternative instruction set. Thus, the instruction converter 294 represents software, firmware, hardware, or a combination thereof that, through emulation, simulation or any other process, allows a processor or other electronic device that does not have an x86 instruction set processor or core to execute the x86 binary code 284.

In addition to or alternative to the translation of code to run on processors without x86 instruction sets, the binary code may be translated for any other suitable reason. Furthermore, when the translation is performed, the code being translated may be optimized by unrolling loops to have fewer loopback instructions, by removing conditional branches that have a branch that is taken relatively often or taken relatively rarely (e.g., 70%, 80%, 90%, 95%, 99%, 99.9%, 99.99%, or more taken/not taken), or any other suitable optimization techniques. Moreover, during the binary translation, the instruction converter 294 may change the order and/or addresses of instructions in the original code.

Loop Unrolling Optimization and Indexed instructions

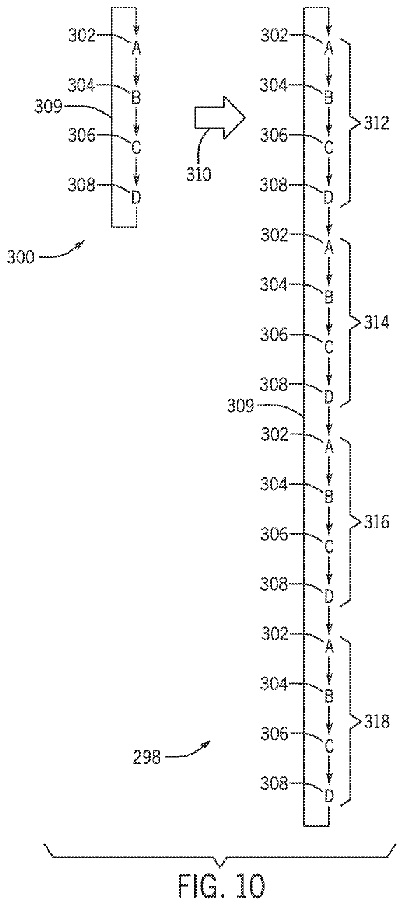

The instruction converter 294 may implement one or more optimizations when translating the code. As previously noted, one optimization that may be implemented during translation is unrolling loops. Loop unrolling includes copying looped instructions and making at least one copy of the looped instructions and removing a backward loop branch between the copies of the looped instructions. For instance, FIG. 10 is a flow diagram of a loop unrolling 298. As illustrated, the original code includes a loop 300 of instructions 302, 304, 306, and 308. Using heuristics, the instruction converter 294 may determine that the loop 300 is typically repeated a number (e.g., 1, 2, 3, 4, or more times) and/or in multiples of the number of instructions (e.g., 4, 8, 12, etc. when four is the number). Accordingly, when that number is four, the translation 310 may unroll the loop four times into iterations 312, 314, 316, and 318 of the instructions 302, 304, 306, and 308. When the iteration 318 is completed, a loop instruction 309 is used to return to the instruction 302 of the iteration 312. Thus, by moving between the addresses of the iterations 312, 314, 316, and 318 without looping, the translated code may be completed more efficiently.

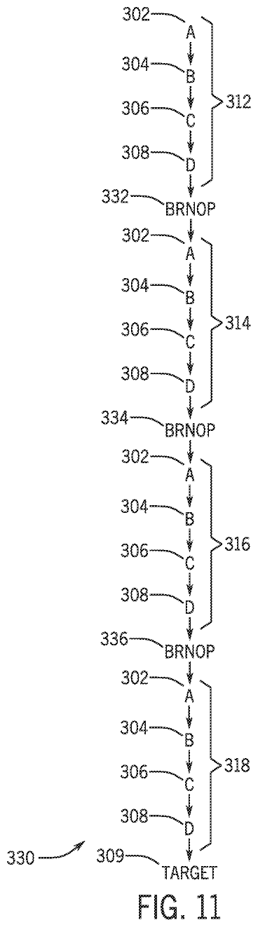

However, original branch behavior must be tracked in binary translation systems and just-in-time (JIT) compiler systems. For binary translation systems, tracking branch behavior is needed for architectural compatibility (e.g., performance monitoring using perfmon, processor trace (PT), or last branch record (LBR)). Properly tracking original branch behavior is also useful for JIT compiler systems for debugging the resulting translation versus the original code. Accordingly, each of the removed backwards loops from the iterations 312, 314, and 316 are to be accounted for in the translated code to track the number of branches (e.g., loopbacks) that are logically taken. Accordingly, each omitted loopback may be replaced with a branch not-an-operation instruction (BRNOP). FIG. 11 shows a translated flow 330 of code that is the same as the translated flow of FIG. 10 except that the omitted loopbacks in the iterations 312, 314, and 316 have been replaced with respective BRNOPs 332, 334, and 336. The addition of the BRNOPs 332, 334, and 336 allow for tracking branch behavior.

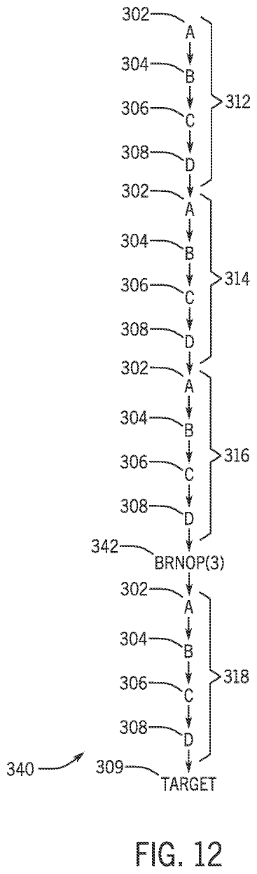

BRNOPs, while technically being not-an-operations (NOPs), still consume resources in and add to the overhead translated code execution and at least partially mitigate the benefits of the optimization in the instruction converter 294. One way to reduce the overhead of adding multiple BRNOPs (e.g., BRNOPs 332, 334, and 336) is to combine multiple BRNOPs together into a single instruction. A numbered BRNOP instruction (BRNOPN) may be utilized where N indicates the number of BRNOPs combined or the number of branches taken that are indicated by the BRNOPs. For instance, in FIG. 12 a translated flow 340 of code is the same as the translated flow 330 of FIG. 11 except that the BRNOPs 332, 334, and 336 of the translated flow 330 have been replaced by a single BRNOPN 342 that has an N value of three. The N value may be indicated in a specified N field of the BRNOPN 342. In other words, BRNOPN 342 combines multiple BRNOPs 332, 334, and 336 into a single instruction where ‘N’ is three as the number of BRNOPs combined. Thus, BRNOPN represents N copies of one static taken branch, such as the backward loop branch, replicated due to loop unrolling in the translated code as described above. BRNOPN just like BRNOP, carries quite a bit of information for LBR and may support only a single static taken branch to avoid making the instruction very large. In some embodiments, BRNOPN supports more than one static taken branch with some savings compared to using two separate BRNOPNs, but each additional support taken branch has diminishing returns.

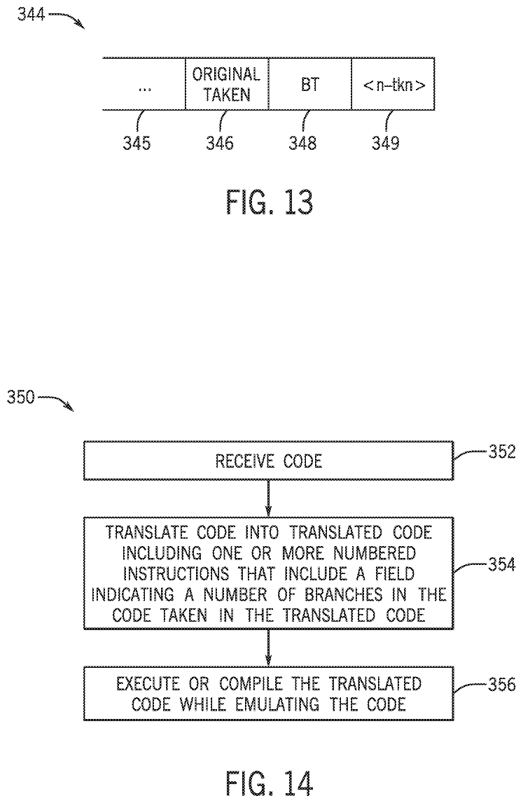

FIG. 13 is a diagram of a data structure 344 of a BRNOPN instruction. As illustrated, the data structure 344 may include a portion 345 that includes information that is typically included in a BRNOP instruction with additional fields. For instance, the data structure 344 includes additional fields of an original taken branch field 346, a branch type (BT) field 348, and a number of branches taken field 349. The original taken branch field 346 indicates an emulated real instruction pointer of the original taken branch to be used by the LBR logic for performance monitoring. The branch type field 348 indicates a type of branch (e.g., a backwards loop branch, conditional branch converted to assert, etc.). This field may be used by LBR, PT, and/or perfmon logic. The number of taken branches field 346 indicates how many branches were folded into the BRNOPN instruction. Although the fields in the data structure 344 are shown in a particular order, the fields in the data structure 344 may have an alternative arrangement that still contains the same data. Furthermore, in some embodiments, at least some of the fields (e.g., the branch type field 348) may be omitted. Additionally, the fields included in the data structure 344 may have specified lengths and/or may be dynamic (e.g., indicated using tag-length-value packets).

FIG. 14 is a flow diagram 350 utilizing indexed instructions (e.g., BRNOPNs and the like) that indicate a number of branches in the code taken in the translated code. The instruction converter 294 receives code (block 352). For instance, a processor used to implement the instruction converter 294 may receive binary code. As previously noted, the instruction converter 294 may be implemented as software running on a processor and/or may be implemented using conversions circuitry included as hardware in the processor. The instruction converter 294 then translates the code into translated code including one or more indexed instructions (e.g., BRNOPNs) that include a field indicating a number of branches in the code taken in the translated code (block 354). For instance, the translation may include a loop unrolling optimization, and the number field indicates the number of loops unrolled in the translated code corresponding to a loop from the code. Thus, the number field indicates the number of branches taken from the original code in the loop unrolled portion of the translated code. The processor may execute the translated code or a compiler implemented using the processor or another process may compile the translated code while emulating the code despite the optimization changing the translated code (block 356).

In some embodiments, BRNOPN may not allow reordering with other interleaving not-taken branches that are not breadcrumbs. For example, two BRNOPs can be combined into one BRNOPN when an ASSERT instruction is between the two BRNOPs, as long as they are part of the same atomic commit block. However, two BRNOPs with an ASSERT.P between them may not be combined in some embodiments. This is because the order of breadcrumb instructions may need to be preserved for a sequence on Taken/Not-Taken packets of PT. This PT rule prevents BRNOPN from being used in many practical scenarios, such as when BRNOPs are separated by conditional branches. In these cases, BRNOPs cannot be moved up or down without knowing the conditional branch outcome. Instead, alternative breadcrumb instructions may be used.

### Extended Instructions and Extended BRNOPN

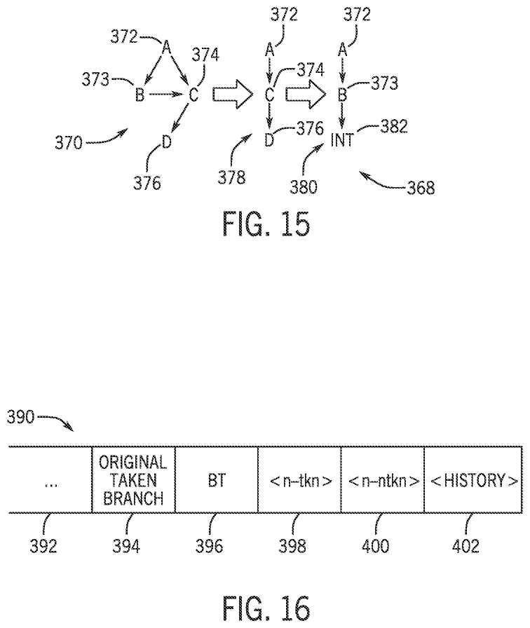

As previously discussed, translation optimizations may include removing conditional branches as part of the optimization when a conditional branch is heavily weighted one way or another. FIG. 15 illustrates a branch-to-assertion optimization 368 from an original flow 370 that starts with an instruction 372. If a condition is satisfied, the flow 370 jumps past an instruction 373 to an instruction 374 then to an instruction 376. If the condition is not met, the flow 370 proceeds through instructions 372, 373, 374, and 376 in the respective order. If the condition is biased in such a way that it is much more likely that one outcome is to occur (e.g., the jump branch to instruction 374), the conditional branch may be replaced with an assertion as shown in the flow 378. This biasing may be determined using heuristics. However, if the branch is not taken during runtime as shown in the flow 380, an assert instruction may be used to evaluate whether the prediction was correct. This test for the value may be made at any time. For instance, a Capture-And-Trap (CAT), a Test-And-Trap (TAT), or other instruction type may determine whether the assumption was correct. If the assumption was incorrect, the flow 380 causes the processor to raise an interrupt 382. In other words, the assert instruction may be made at the time that the interrupt 382 is made.

As previously noted, BRNOPNs may be unsuitable for optimizations where conditional branches are between two BRNOPs since BRNOPs do not track branches not taken. Instead, an Extended BRNOPN (EBRNOPN) instruction may be used. The EBRNOPN enables the representation of a number of interleaving not-taken conditional breadcrumb instructions. For example, these not-taken breadcrumbs may occur as ASSERT instructions in the code, such as a result of branch-to-assert optimization. LBR records do not need not-taken branch information, and PT only needs to know the pattern of the taken and not-taken condition of the original instructions. Accordingly, the optimization can replace the ASSERT.Ps with ASSERTs once the branch representations are fused into an EBRNOPN. The ASSERTs do not need to be allocated into the branch ordering queue anymore and, therefore, do not artificially reduce front end throughput. EBRNOP can support the not-taken conditional breadcrumbs occurring in any order relative to the taken breadcrumbs that are fused into the EBRNOP instruction. In some embodiments, the only restriction for ENRNOPNs, like BRNOPNs, is that they be in the same atomic commit region and the original code for this region. Furthermore, EBRNOPN may be placed by the translator at a location which guarantees that all branches represented by the EBRNOPN either all are executed or none are executed.

FIG. 16 is a block diagram of a data structure 390 of an EBRNOPN instruction. As illustrated, data structure 390 may include a portion 392 that includes information that is typically included in a BRNOP instruction with additional fields. For instance, as in data structure 344, data structure 390 includes the additional fields of an original taken branch field 394, a branch type (BT) field 396, and a number of branches taken field 398. The original taken branch field 394 indicates an emulated real instruction pointer of the original taken branch to be used by the LBR logic for performance monitoring. The branch type field 396 indicates a type of branch (e.g., a backwards loop branch, conditional branch converted to assert, etc.). This field may be used by LBR, PT, and/or perfmon logic. The number of taken branches field 398 indicates how many branches were folded into the BRNOPN instruction.

As previously noted, unlike a BRNOPN instruction, the EBRNOPN instruction tracks a number of branches not taken. To track the number of branches not taken, data structure 390 includes a number of not taken branches field 400. Since the EBRNOPN instruction may contain both branches taken and not taken, a history field 402 may be used that tracks the order of taken and not taken branches in the original code. For instance, the history field 402 may be a bit vector where each bit corresponds to a branch with a first value (e.g., 0) indicating a branch not taken and a second value (e.g., 1) indicating that a branch taken. Although the fields in the data structure 390 are shown in a particular order, the fields in the data structure 390 may have an alternative arrangement that still contains the same data. Furthermore, in some embodiments, at least some of the fields may be omitted. For instance, the branch not taken field 400 may be omitted when the branch taken field 398 and the history field 402 are included since the branches not taken is inherent in the data using the other two fields and may be derived from the branch taken field 398 and the history field 402.

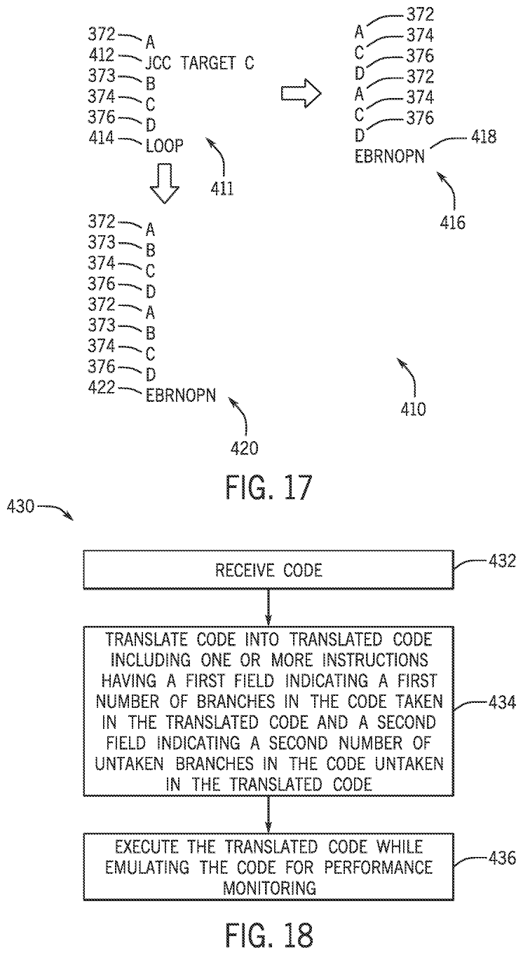

FIG. 17 illustrates branch-to-assertion optimization 410 showing alternative fusings of the branch-to-assertion outcomes. The instructions 372, 373, 374, and 376 are shown in original code 411 with a jump branch 412 and a branch loop 414. In translated code 416, the jump branch 412 is fused as an assertion that the flow always goes from operation A 372 to operation C 374 (without the explicit JCC target C branching or first going to operation B 373), and the loop is unrolled one time. An EBRNOPN instruction 418 is included to emulate the branches for performance monitoring. The branches taken field 398 of the EBRNOPN instruction 418 indicate that three branches are taken with two of the jump branches 412 taken and one of the loop 414 branches are taken. The branches not taken field 400 of the EBRNOPN instruction 418 may indicate that no branches were not taken. In this example, history field 402 may include a string of “111”.

If translated code 420 is generated instead of translated code 416, the fields of the EBRNOPN 422 would have different values to track the different branching. Specifically, the branches taken field 398 would indicate that a single branch, the loop branch, is taken while the branches not taken field 400 would indicate that two branches of the jump branch 412 are not taken. Accordingly, in this example, history field 402 may have a string of 010.

Furthermore, although branch-to-assertion optimizations may utilize the same order as illustrated above, in some embodiments, the branches may be fused as not taken and the instructions are inverted when translated/optimized. Additionally, the fields included in the data structure 390 may have specified lengths and/or may be dynamic (e.g., indicated using tag-length-value packets).

FIG. 18 is a flow diagram 430 utilizing extended instructions (e.g., EBRNOPNs and the like) that indicate a first number of branches taken and a second number of branches not taken in the code taken in the translated code. The instruction converter 294 receives code (block 432). For instance, a processor used to implement the instruction converter 294 may receive binary code. As previously noted, the instruction converter 294 may be implemented as software running on a processor and/or may be implemented using conversions circuitry included as hardware in the processor. The instruction converter 294 then translates the code into translated code including one or more instructions (e.g., EBRNOPNs) that include a field indicating a first number of branches in the code taken in the translated code and a second number of branches in the code not taken in the translated code (block 434). For instance, the translation may include a branch-to-assert optimization with the first number field indicating the number of branches take and the second number field indicating the number of branches not taken in the translated code. The EBRNOPN may also include a history field that tracks the order of taken and untaken branches. For instance, the history field may include a bit vector that has a bit for each branch with each bit having a first value (e.g., 0) corresponding to a branch not taken and a second value (e.g., 1) corresponding to a branch taken. In some embodiments, the second number may be explicitly included in a branches taken field. Alternatively, the branches not taken field may be omitted since the number of branches not taken may be derived from the branches taken field and the history field. In other words, the EBRNOPN includes the second number of branches not taken as data in the history field when also combined with the first number of branches taken in the branches take field. Moreover, in further embodiments, the branches taken field may be omitted instead of the branches not taken field since the number of branches taken may be derived from the branches not taken field and the history field. The processor may execute the translated code or a compiler implemented using the processor or another process may compile the translated code while emulating the code despite the optimization changing the translated code (block 436).

### EXAMPLE EMBODIMENTS

EXAMPLE EMBODIMENT 1. A system comprising: memory to store instructions; and a processor comprising an instruction converter to: receive the stored instructions; and translate the stored instructions into translated code that includes one or more indexed instructions that include a field indicating a number of branches in the stored instructions that are taken in the translated code.

EXAMPLE EMBODIMENT 2. The system of example embodiment 1 comprising a binary translation processor to execute the translated code.

EXAMPLE EMBODIMENT 3. The system of example embodiment 1 comprising a just-in-time compiler to compile the translated code.

EXAMPLE EMBODIMENT 4. The system of example embodiment 1, wherein the instruction converter is implemented using software executed by an execution unit of the processor.

EXAMPLE EMBODIMENT 5. The system of example embodiment 1, wherein the processor comprises hardware circuitry that implements the instruction converter.

EXAMPLE EMBODIMENT 6. The system of example embodiment 1, wherein translating the stored instructions comprises optimizing the translated code to execute more efficiently than without optimization.

EXAMPLE EMBODIMENT 7. The system of example embodiment 6, wherein the optimization comprises loop unrolling looped instructions a number of times equal to the number of branches in the field.

EXAMPLE EMBODIMENT 8. The system of example embodiment 7, wherein the unrolled loop of instructions comprises a plurality of iterations each having a backward loop branch of the loop that are combined and replaced with a indexed instruction of the one or more indexed instructions.

EXAMPLE EMBODIMENT 9. The system of example embodiment 8, wherein a number of iterations in the plurality of iterations is equal to number of taken branches in the field.

EXAMPLE EMBODIMENT 10. The system of example embodiment 6, wherein the one or more indexed instructions comprise a branch type field that indicates a type of branch taken as indicated by the number of branches in the.

EXAMPLE EMBODIMENT 11. The system of example embodiment 10, wherein the branch type field indicates a backward loop branch when the optimization comprises loop unrolling.

EXAMPLE EMBODIMENT 12. The system of example embodiment 6, wherein the one or more indexed instructions comprises an original taken branch that indicates an emulated real instruction pointer of an original taken branch from the instructions translated in the translated code.

EXAMPLE EMBODIMENT 13. The system of example embodiment 6, wherein the one or more indexed instructions comprise a branches not taken field indicating a number of branches in the instructions that are not taken in the translated code.

EXAMPLE EMBODIMENT 14. The system of example embodiment 13, wherein the one or more indexed instructions comprise a history field that indicates an order branches both taken and not taken from the instructions when translated into the translated code.

EXAMPLE EMBODIMENT 15. The system of example embodiment 13, wherein the optimization comprises translating a conditional branch to an assertion.

EXAMPLE EMBODIMENT 16. A system comprising: memory to store original code; and

a processing system comprising: an instruction converter to: receive the original code; and translate the original code into translated code that includes an instruction that includes a first field indicating a first number of branches in the original code that are taken in the translated code and that includes a second field indicating a second number of branches in the original code not taken in the translated code; and an execution unit to execute instructions.

EXAMPLE EMBODIMENT 17. The system of example embodiment 16, wherein the second field comprises a history field that indicates an order of the taken and untaken branches.

EXAMPLE EMBODIMENT 18. The system of example embodiment 17, wherein the history field comprises a bit vector where each bit of the bit vector corresponds to a respective branch, and a value of the bit indicated whether the respective branch was taken or not taken.

EXAMPLE EMBODIMENT 19. A method comprising: receiving, at an instruction converter of a processor, code comprising a plurality of instructions; translating, using the instruction converter, the code into translated code including an instruction that includes a first field indicating a number of branches in the original code taken in the translated code and a second field indicating a number of branches in the original code not taken in the translated code, wherein translating comprises optimizing the translated code to run more efficiently than when optimized; and executing or compiling the translated code.

EXAMPLE EMBODIMENT 20. The method of example embodiment 19 comprising utilizing performance monitors to monitor performance of execution of the translated code using the instruction to emulate execution of the code rather than the translated code.

EXAMPLE EMBODIMENT 21. The method of example embodiment 20 wherein the performance monitors comprise perfmon, processor trace (PT), or last branch record (LBR) performance monitoring.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
memory to store instructions; and
a processor comprising an instruction converter to:
receive the stored instructions; and
translate the stored instructions into translated code that includes one or more numbered instructions that include a field indicating a number of branches in the stored instructions that are taken in the translated code.

2. The system of claim 1 comprising a binary translation processor to execute the translated code.

3. The system of claim 1 comprising a just-in-time compiler to compile the translated code.

4. The system of claim 1, wherein the instruction converter is implemented using software executed by an execution unit of the processor.

5. The system of claim 1, wherein the processor comprises hardware circuitry that implements the instruction converter.

6. The system of claim 1, wherein translating the stored instructions comprises optimizing the translated code to be execute more efficiently by the processor than without optimization.

7. The system of claim 6, wherein the optimization comprises loop unrolling looped instructions a number of times equal to the number of branches indicated in the field.

8. The system of claim 7, wherein the unrolled looped instructions comprises a plurality of iterations each having a backward loop branch of the loop that are combined and replaced with a indexed instruction of the one or more indexed instructions.

9. The system of claim 8, wherein a number of iterations in the plurality of iterations is equal to a number of taken branches in the field.

10. The system of claim 6, wherein the one or more indexed instructions comprise a branch type field that indicates a type of branch taken as indicated by the number of branches in the translated code.

11. The system of claim 10, wherein the branch type field indicates a backward loop branch when the optimization comprises loop unrolling.

12. The system of claim 6, wherein the one or more indexed instructions comprises an original taken branch that indicates an emulated real instruction pointer of the original taken branch from the instructions in the translated code.

13. The system of claim 6, wherein the one or more indexed instructions comprise a branches not taken field indicating a number of branches in the instructions that are not taken in the translated code.

14. The system of claim 13, wherein the one or more indexed instructions comprise a history field that indicates an order of branches both taken and not taken from the instructions when translated into the translated code.

15. The system of claim 13, wherein the optimization comprises translating a conditional branch to an assertion.

16. A system comprising:
memory to store original code; and
a processing system comprising:
an instruction converter to:
receive the original code; and
translate the original code into translated code that includes an instruction including a first field indicating a first number of branches in the original code that are to be taken in the translated code when executed and including a second field indicating a second number of branches in the original code to not be taken in the translated code when executed; and
an execution unit to execute instructions of the translated code.

17. The system of claim 16, wherein the second field comprises a history field that indicates an order of taken and untaken branches.

18. The system of claim 17, wherein the history field comprises a bit vector where each bit of the bit vector corresponds to a respective branch, and a value of the bit indicates whether the respective branch is to be taken or is not to be taken.

19. A method comprising:
receiving, at an instruction converter of a processor, original code comprising a plurality of instructions;
translating, using the instruction converter, the original code into translated code including an instruction that includes a first field indicating a number of branches in the original code taken in the translated code and a second field indicating a number of branches in the original code not taken in the translated code, wherein translating comprises optimizing the translated code to run more efficiently by the processor than when optimized; and
executing or compiling the translated code by the processor.

20. The method of claim 19 comprising utilizing a performance monitor to monitor performance of execution of the translated code using an instruction to emulate execution of the original code rather than the translated code.

21. The method of claim 20 wherein the performance monitor comprise one of perfmon, processor trace (PT), or last branch record (LBR) performance monitoring.
